(19) United States
(12) Patent Application Publication
(10) Pub. No.: US 2025/0387301 A1
(43) Pub. Date: Dec. 25, 2025

(54) Two In One Feeding Bottle(2in1)

(71) Applicant: Venita Renell Beaty, Woodruff, SC (US)

(72) Inventor: Venita Renell Beaty, Woodruff, SC (US)

(21) Appl. No.: 17/954,041

(22) Filed: Sep. 27, 2022

(51) Int. Cl. A61J 9/00; A61J 11/04; B65D 21/08

(52) U.S. Cl. CPC A61J 9/00; A61J 11/04; B65D 21/083

(57) ABSTRACT

The Two In One Feeding Bottle (2n1) offers two different bottle sizes and serving portions in one bottle. When bottom and top parts are connected by twisting together at the middle they make a one piece whole bottle that can offer full amount or large size feeding portions. The bottom part of bottle can detach apart by twisting from middle of bottle to disconnect from top part of bottle and becomes two separate parts. The bottom part offers second option of a smaller size bottle and serving portion. The one nipple cap twists to attach and detach can fit top part when it's as a whole bottle also fits bottom smaller part when it's detached from top part, becoming second smaller part bottle to provide smaller servings when desired. When top and bottom parts are twisted together they connect to make a whole bottle.

### BACKGROUND

A typical plastic feeding bottle that dispenses liquid for feeding consisting of two portion parts

When separated at the middle by twisting, giving two bottle sizes in one bottle.

This invention can be a transition bottle developed to increase multiple usage and functionality from one bottle.

### FIELD OF INVENTION

Relates to general infant feeding

### SUMMARY OF INVENTION

This invention related to plastic infant feeding bottle made of two parts that gives a full and half bottle sizes from one bottle that can also be used as transition bottle. This invention has one compatible nipple cap that fits the two option sizes from the one bottle.

### DESCRIPTION OF DRAWINGS

FIG. 1 Shows the bottle as one whole bottle.

FIG. 1 Shows parts 1 the compatible nipple cap that fits top of upper of 2 f the bottle.

FIG. 1 Shows part 2 is upper part of bottle when it's connected as a whole bottle.

FIG. 1 Shows part 3 a visible seam line in middle where the upper and bottom bottle parts are connected.

FIG. 1 Shows when 2 and 4 are attached together making one whole sized portion bottle.

FIG. 1 Shows parts 2 and 4 of bottle attached together making one whole bottle.

FIG. 2 Shows top parts 2 as the upperpart and 4 the bottom parts are detached from one another by untwisting apart to separate while showing 5, the threaded part that when twisted connects and detaches the upper part of bottle from the bottom part to make two make two parts and two portion sizes.

FIG. 3 Shows 1 as the compatible nipple cap that is detached by twisting off away and up from the 2 the upper part of bottle.

FIG. 3 Shows 3 Shows 2 as detached from the compatible nipple cap and from the bottom part of bottle.

FIG. 3 Shows revealing thread at bottom of 2 when separated from 4.

FIG. 3 Shows 4 separated from 2.

FIG. 4 Shows 2 the upper part of the bottle as separated upper part of bottle.

FIG. 4 Shows 4 as bottom part with the compatible nipple cap is reattached to the stand-alone bottom part becoming the second smaller bottle size portion from the one bottle.

### DESCRIPTION

A plastic feeding bottle that can be a large portion bottle size when it is a whole one-piece bottle when the compatible nipple cap and the upper and bottom parts are all connected. The feeding bottle untwist at the middle revealing the threading that connects and separates the bottle into two parts. The nipple cap, the upper part of bottle and the bottom part are all separated from each other. The compatible nipple cap is reattached to and fits the smaller portion bottle size that is revealed from the bottom part of the bottle revealing the second bottle option size and measured portion.

A feeding bottle consisting of two parts offering two sizes and servings in one bottle. The Two In One Bottle feeding bottle is plastic and offers two size bottles and portions from one bottle. The Two In One Feeding Bottle can be a transition bottle using the smaller portion and size for infants and the large size portion for older child. Having two bottles sizes in one can decrease excessive amounts of bottle and can save space.

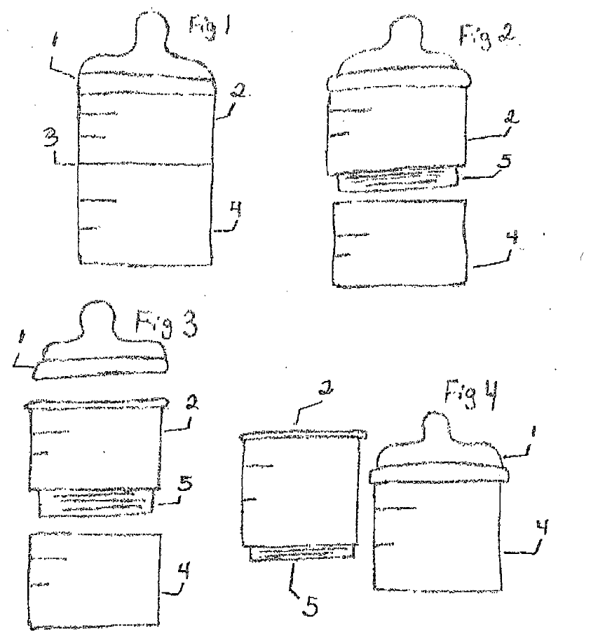

FIG. 1 Shows the invention as a whole bottle with attached flexible soft nipple cap.

FIG. 2 Shows the top half part and bottom half untwist to detach at the middle to make two parts and two portion sizes.

FIG. 3 Shows the compatible nipple on top part twist off of the bottle. All three parts detach by untwisting apart.

FIG. 4 Shows the nipple cap twist back on and is reattached to bottom half of bottle that becomes second smaller stand-alone serving size bottle portion.

1. An apparatus that provides multiple feeding option sizes
An apparatus comprising of a detachable twist off flexible soft nipple on top to dispense and allow in the beverage.
a means that the flexible soft nipple fits the top of the two connecting parts
a means that the soft flexible nipple cap also fits the bottom of the two connecting part when it is detached from the top container by twisting away

2. An apparatus comprising of two connecting plastic parts, comprising:
a means that two parts connect together by twisting together to make one apparatus
a means that when the apparatus is separated by untwisting, the bottom part becomes the second smaller container for beverages
a means that transitions feeding amounts sizes with need
a means that the soft flexible nipple fits the bottom and top container

3. An apparatus for holding and refilling hot or cold beverage, comprising:
a means for containing beverage
a means for dispensing beverage
a means having two section parts and nipple that is compatible and fits onto both parts providing use of the two bottle parts
a means for comprising two measured portion containers
a means for transitioning sizes and need
